(19) United States
(12) Patent Application Publication
(10) Pub. No.: US 2012/0049107 A1
(43) Pub. Date: Mar. 1, 2012

(54) SLURRY COMPOSITION FOR CHEMICAL MECHANICAL POLISHING PROCESS AND METHOD OF FORMING PHASE CHANGE MEMORY DEVICE USING THE SAME

(76) Inventors: Joonsang PARK, Seoul (KR); Euihoon JUNG, Suwon-si (KR); Boun YOON, Seoul (KR); Jaedong LEE, Seongnam-si (KR)

(21) Appl. No.: 13/212,448

(22) Filed: Aug. 18, 2011

(30) Foreign Application Priority Data
Aug. 30, 2010 (KR) 10-2010-0084228

(51) Int. Cl. C09K 13/04; C09K 13/00

(52) U.S. Cl. 252/79.2; 252/79.1

(57) ABSTRACT

A slurry composition for chemical mechanical polishing of a polishing target layer containing a phase change material and a method of forming a phase change memory device using the same, the slurry composition including abrasive particles; and a nonionic surfactant, wherein a concentration of the nonionic surfactant in the slurry composition is about 100 ppb to about 300 ppb.

### CROSS-REFERENCE TO RELATED APPLICATIONS

This application claims priority under 35 U.S.C. §119 to Korean Patent Application No. 10-2010-0084228, filed on Aug. 30, 2010, in the Korean Intellectual Property Office, and entitled: “Slurry Composition for Chemical Mechanical Polishing Process and Method of Forming Phase Change Memory Device Using the Same,” which is incorporated by reference herein in its entirety.

### BACKGROUND

1. Field

Embodiments relate to a slurry composition used for a chemical mechanical polishing process and a method of forming a semiconductor device using the same.

2. Description of the Related Art

According to the recent rapid increase in the widespread use of digital cameras, camcorders, MP3, digital multimedia broadcasting (DMB), navigations, mobile phones, and the like, requirements for high-performance and high-capacity semiconductor memory devices are increasing as well as the demand for semiconductor memory devices. Therefore, development of next-generation semiconductors for overcoming the limitations of typical memory devices has recently been actively pursued. For next-generation semiconductors, phase change random access memory (PRAM), magnetoresistive random access memory (MRAM), ferroelectric random access memory (FeRAM), polymer random access memory, and the like have been suggested. Among these memories, PRAM is a non-volatile memory that records data using a material capable of generating a reversible phase transition between crystalline and amorphous phases through Joule heating using application of current or voltage. PRAM may have advantages of high integration density, high-speed operation, non-volatile characteristics, and the like. Therefore, research on ways to improve electrical properties and reliability of this phase change random access memory is currently underway.

### SUMMARY

Embodiments are directed to a slurry composition used for a chemical mechanical polishing process and a method of forming a semiconductor device using the same.

The embodiments may be realized by providing a slurry composition for chemical mechanical polishing of a polishing target layer containing a phase change material, the slurry composition including abrasive particles; and a nonionic surfactant, wherein a concentration of the nonionic surfactant in the slurry composition is about 100 ppb to about 300 ppb.

The abrasive particles may include at least one of ceria, silica, alumina, titania, zirconia, mangania, and germania.

The abrasive particles may include polymer synthetic particles.

The nonionic surfactant may include at least one of a polymer material containing a hydroxyl group, a polymer material containing an ester bond, a polymer material containing an acid amide bond and a polymer material containing an ether bond.

The composition may further include at least one of a pH value regulator and an oxidant.

The composition may include the pH value regulator, the pH value regulator including at least one of an inorganic acid, an organic acid, and a base.

The pH value regulator may include nitric acid.

The composition may include the oxidant, the oxidant including at least one of hydrogen peroxide, a monopersulfate compound, a dipersulfate compound, an ionic iron compound, and an iron chelate compound.

The phase change material may contain a chalcogenide compound.

The chalcogenide compound may be a germanium-antimony-tellurium (GST) compound.

The embodiments may also be realized by providing a method of forming a phase change memory device, the method including forming a phase change material layer on a substrate; and performing a chemical mechanical polishing process on the phase change material layer, wherein the chemical mechanical polishing process is performed using a slurry composition containing abrasive particles and a nonionic surfactant, a concentration of the nonionic surfactant in the slurry composition being about 100 to about 300 ppb.

The method may further include, prior to forming the phase change material layer, forming a dielectric layer on the substrate; and forming an opening in the dielectric layer, wherein the phase change material layer is formed on the dielectric layer with the opening and the chemical mechanical polishing process is performed until the dielectric layer is exposed.

The nonionic surfactant may include at least one of a polymer material containing a hydroxyl group, a polymer material containing an ester bond, a polymer material containing an acid amide bond, and a polymer material containing an ether bond.

The slurry composition may further include at least one of a pH value regulator and an oxidant.

The slurry composition may include the oxidant, the oxidant including at least one of hydrogen peroxide, a monopersulfate compound, a dipersulfate compound, an ionic iron compound, and an iron chelate compound.

The phase change material layer may contain a chalcogenide compound.

The chalcogenide compound may be a germanium-antimony-tellurium (GST) compound.

The embodiments may also be realized by providing a chemical mechanical polishing slurry composition including abrasive particles; and a nonionic surfactant, wherein the slurry composition has a layer removal rate of about 2,284 Å/min to about 326 Å/min when used to polish a phase change material layer.

The slurry composition may cause dishing of about 40 Å or less when used to polish a phase change material layer.

### BRIEF DESCRIPTION OF THE DRAWINGS

The embodiments will become more apparent to those of ordinary skill in the art by describing in detail exemplary embodiments with reference to the attached drawings, in which:

FIG. 1 illustrates a perspective view of a chemical mechanical polishing apparatus that uses a slurry composition according to an embodiment;

FIG. 2 illustrates a cross-sectional view taken along line I-I′ in FIG. 1;

FIG. 3 illustrates an enlarged cross-sectional view of region A of FIG. 2;

FIGS. 4A through 4D illustrate cross-sectional views of stages in a method of forming a phase change memory device according to an embodiment;

FIG. 4E illustrates a cross-sectional view of a modified embodiment of the method of forming a phase change memory device;

FIG. 5 illustrates a graph showing a decreasing amount of defects depending on a concentration of a nonionic surfactant according to the embodiments;

FIG. 6 illustrates a graph showing a dishing amount depending on the concentration of a nonionic surfactant according to the embodiments; and

FIG. 7 illustrates a graph showing a removal rate of a layer depending on the concentration of a nonionic surfactant according to the embodiments.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout.

In the following description, the technical terms are used only for explaining specific embodiments while not limiting the present invention. In the inventive concept, the terms of a singular form may include plural forms unless otherwise specified. The meaning of “include,” “comprise,” “including,” or “comprising,” specifies a property, a region, a fixed number, a step, a process, an element and/or a component but does not exclude other properties, regions, fixed numbers, steps, processes, elements and/or components.

Though terms like a first, a second, and a third are used to describe various regions and layers in various embodiments of the present invention, the regions and the layers are not limited to these terms. These terms are used only to differentiate one region or layer from another region or layer. Therefore, a layer referred to as a first layer in one embodiment can be referred to as a second layer in another embodiment. An embodiment described and exemplified herein includes a complementary embodiment thereof.

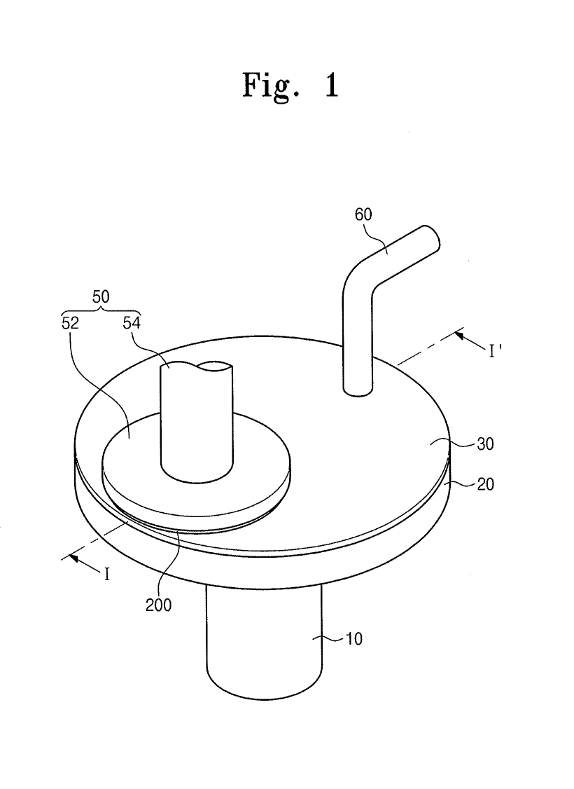

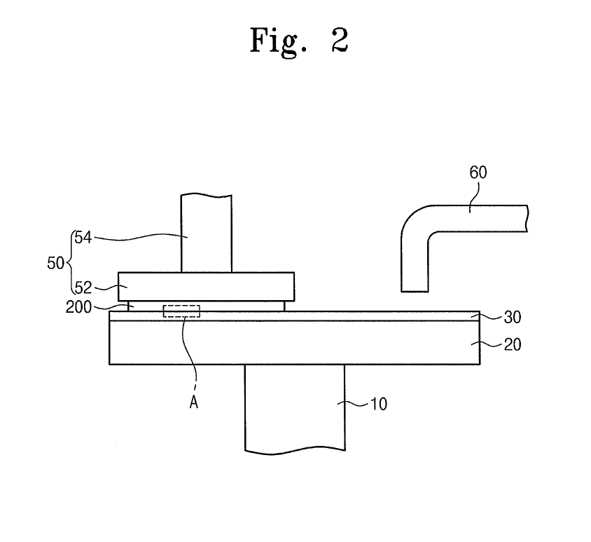

FIG. 1 illustrates a perspective view of a chemical mechanical polishing apparatus that uses a slurry composition according to an embodiment. FIG. 2 illustrates a cross-sectional view taken along line I-I′ in FIG. 1.

Referring to FIGS. 1 and 2, a polishing apparatus used for a chemical mechanical polishing process may include a central shaft 10 and a polishing table 20 mounted on the central shaft 10. A polishing pad 30 may be mounted on the polishing table 20. The polishing pad 30 may be formed of, e.g., rigid polyurethane or a non-woven polyester felt material impregnated or coated with the polyurethane. The polishing pad 30 may include a plurality of pores and a plurality of protrusions formed on the pad surface. Mechanical polishing may be performed by the pores and protrusions. The polishing table 20 and the polishing pad 30 may have a circular plate shape when viewed from the top thereof. When viewed from the top, the polishing table 20 may have a circular plate shape having a larger diameter than the polishing pad 30. The polishing table 20 and the polishing pad 30 may be rotated by rotation of the central shaft 10. A mechanical polishing process may be performed by the rotation of the polishing pad 30.

The polishing apparatus may further include a polishing head 50 positioned over the polishing pad 30. The polishing head 50 may include a fixed portion 52 (to which a wafer 200 may be attached) and a rotating portion 54 (for rotating the fixed portion 52 and pressing the wafer 200). The fixed portion 52 may have a circular plate shape having a smaller diameter than the polishing table 20 and the polishing pad 30 when viewed from the top thereof

The wafer 200 may be attached to the fixed portion 52 such that the pad 30 and a polished surface of the wafer 200 face each other. The wafer 200 (attached to the polishing head 50) may be moved by the polishing head 50. Also, when the polishing head 50 applies a constant pressure to the wafer 200 such that the wafer 200 and the polishing pad 30 closely adhere to each other, the polishing head 50 may perform a chemical mechanical polishing process on the wafer 200 by rotating the polishing head 50 by the rotating portion 54.

The polishing apparatus may further include a slurry supply unit 60 mounted over the polishing pad 30. The slurry supply unit 60 may include a slurry storage container for storing a slurry composition used for polishing, a supply line transferring the slurry composition, and a nozzle for discharging the slurry composition from an end of the supply line. One or more of the nozzles may be included. The slurry supply unit 60 may provide a slurry composition to the polishing pad 30. By the rotation of the polishing pad 30, a slurry composition (supplied to a portion of the polishing pad 30 by the slurry supply unit 60) may move to a surface where the wafer 200 and the polishing pad 30 are in contact with each other. Subsequently, the slurry composition may contact a polished surface of the wafer 200, thereby facilitating a chemical reaction with a polishing target layer in the wafer 200.

<Slurry Composition>

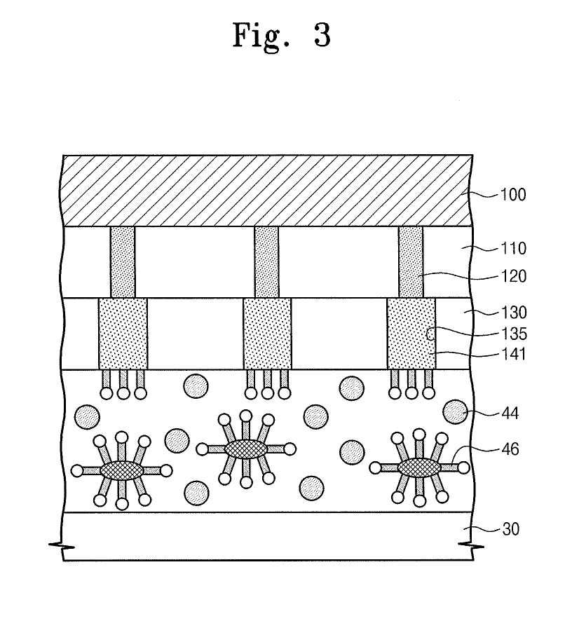

FIG. 3 illustrates an enlarged cross-sectional view of region A of FIG. 2.

Referring to FIG. 3, between the wafer 200 (in which a polishing target layer 141 containing a phase change material is formed) and the polishing pad 30, a slurry composition may be supplied to perform a chemical mechanical polishing on the polishing target layer 141.

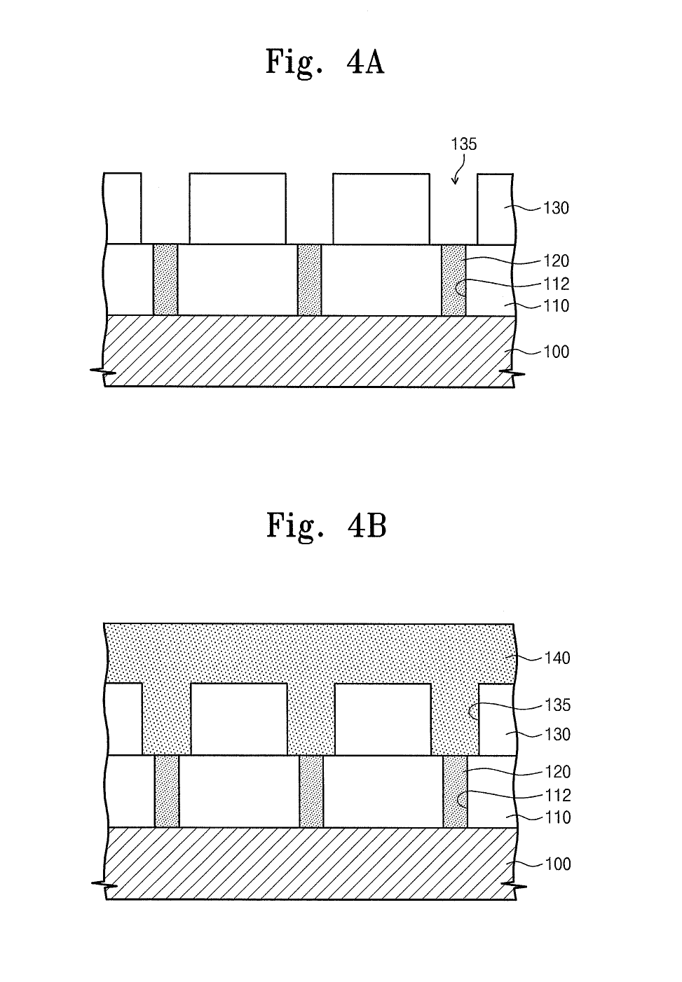

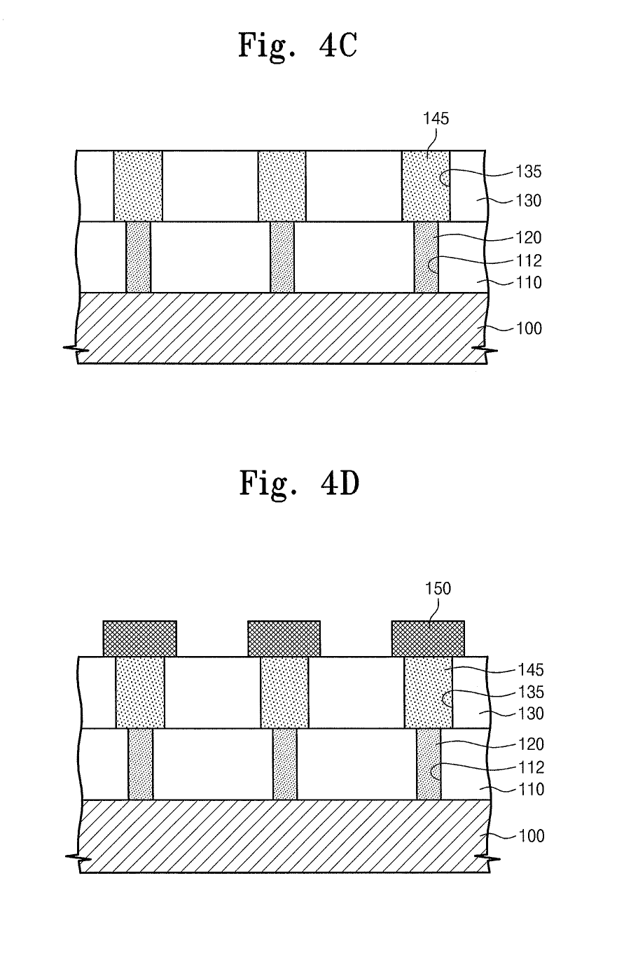

The wafer 200 may include a first insulation layer 110 (on a substrate 100) and a lower electrode 120. Also, the wafer 200 may include an opening 135 (see FIG. 4A) exposing a surface of the lower electrode 120, and may include a second insulation layer 130 on the first insulation layer 110. The polishing target layer 141 (which contains a phase change material filling the opening 135) may be disposed in the second insulation layer 130.

A slurry composition according to an embodiment may be supplied between the polishing target layer 141 and the polishing pad 30.

The slurry composition may include abrasive particles 44 and a nonionic surfactant 46. The slurry composition may be a mixed composition of the abrasive particles 44 and the nonionic surfactant 46 in deionized water.

The abrasive particles 44 may include, e.g., metal oxide, polymer synthetic particles, and combinations thereof For example, the metal oxide may include at least one of ceria, silica, alumina, titania, zirconia, mangania, and germania. The polymer synthetic particles may include at least one of abrasive particles including a polymer itself, abrasive particles of metal oxide coated with a polymer, and abrasive particles of a polymer coated with metal oxide. The abrasive particles 44 may have an average particle diameter of about 1 to about 300 nm and an average specific surface area of about 10 to about 500 m²/g. The slurry composition may include about 0.01 to about 30 wt % of the abrasive particles 44. The abrasive particles 44 may mechanically polish the surface of the polishing target layer 141 (containing the phase change material) in the chemical mechanical polishing process.

The nonionic surfactant 46 may contain a hydrophilic group portion and a hydrophobic group portion. The nonionic surfactant 46 may include at least one of a polymer material containing a hydroxyl group, a polymer material containing an ester bond, a polymer material containing an acid amide bond, and a polymer material containing an ether bond. Herein, the hydroxyl group, the ester bond, the acid amide bond, and the ether bond may be a hydrophilic group portion. For example, the nonionic surfactant 46 may be a material represented by the following formula. In the following formula, x and y may be natural numbers larger than 0.

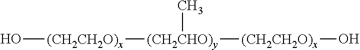

In a chemical mechanical polishing process, a polishing residue, which may be generated during the chemical mechanical polishing process, may float in the slurry composition between the wafer 200 and the polishing pad 30. For example, the nonionic surfactant 46 (contained in the slurry composition) may be adsorbed such that the hydrophilic group portion thereof is oriented toward the wafer 200 (e.g., an opposite direction relative to the polishing residue); and the hydrophobic group portion may contact a surface of the polishing residue. Therefore, readsorption of the polishing residue on the wafer 200 may be minimized. Also, the hydrophobic group portion of the nonionic surfactant 46 may be adsorbed on the surface of the polishing target layer 141, thus facilitating performance of a passivation function to the polishing target layer 141. Therefore, the occurrence of dishing on the surface of the polishing target layer 141 may be minimized.

The nonionic surfactant 46 may be included in the slurry composition in a concentration of about 100 to about 300 ppb. Depending on the concentration of the nonionic surfactant 46 in the slurry composition, a number of defects and occurrence of dishing in the chemical mechanical polishing process may be changed. For example, maintaining the concentration of the nonionic surfactant 46 in the slurry composition at about 100 ppb or greater may help prevent an increase in defects on the wafer 200 in the chemical mechanical polishing process. Maintaining the concentration of the nonionic surfactant 46 in the slurry composition at about 300 ppb or less may help prevent a reduction in the removal rate of the polishing target layer 141.

Experiments were performed for confirming characteristics of a slurry composition according to the embodiments. For the experiments, samples 1 through 5 were prepared as described in Table 1, below. Each of the samples 1 through 5 contained about 0.5 wt % of colloidal silica (SiO₂), about 35 mL/L of hydrogen peroxide (H₂O₂ 30%), about 0.05 mL/L of nitric acid, and deionized water. Herein, colloidal silica (SiO₂) is abrasive particles, hydrogen peroxide (H₂O₂ 30%) is an oxidant, and nitric acid is a pH value regulator.

Sample 1 was a slurry composition containing no nonionic surfactant; and sample 2 was a slurry composition containing a nonionic surfactant in a concentration of about 50 ppb. The samples 1 and 2 may correspond to comparative examples for comparing the characteristics of a slurry composition according to the embodiments. Sample 3 was a slurry composition containing a nonionic surfactant in a concentration of about 100 ppb, sample 4 was a slurry composition containing a nonionic surfactant in a concentration of about 200 ppb, and sample 5 was a slurry composition containing a nonionic surfactant in a concentration of about 300 ppb. The samples 3 through 5, (which represent slurry compositions according to the embodiments) are exemplary embodiments for describing the characteristics of a slurry composition according to the embodiments.

TABLE 1

| | | Nonionic | Hydrogen | |
|---|---|---|---|---|
| | Silica | surfactant | peroxide | Nitric acid |
| | (wt %) | (ppb) | (mL/L) | (mL/L) |
| Sample 1 | 0.5 | 0 | 35 | 0.05 |
| Sample 2 | 0.5 | 50 | 35 | 0.05 |
| Sample 3 | 0.5 | 100 | 35 | 0.05 |
| Sample 4 | 0.5 | 200 | 35 | 0.05 |
| Sample 5 | 0.5 | 300 | 35 | 0.05 |

Using the slurry compositions, a chemical mechanical polishing process was performed on a polishing target layer containing a phase change material according to the following polishing conditions. A polishing target layer used for evaluation was a Ge₂Sb₂Te₅ (GST) layer in which a composition ratio of germanium (Ge), antimony (Sb), and tellurium (Te) was about 2:2:5. A F-REX200 polishing apparatus from the EBARA Corporation was used; and the polishing was performed under conditions of: a polishing pressure of about 216 hPa, a rotational speed of a polishing head of about 100 rpm, and a rotational speed of a polishing table of about 80 rpm.

TABLE 2

| | Number of reduced | Dishing amount | Layer removal rate |
|---|---|---|---|
| | defects | (Å) | (Å/min) |
| Sample 1 | 0 | 170 | 5,000 |
| Sample 2 | 20,000 | 160 | 4,807 |
| Sample 3 | 143,000 | 40 | 2,284 |
| Sample 4 | 149,800 | 20 | 1,393 |
| Sample 5 | 149,850 | 0 | 326 |

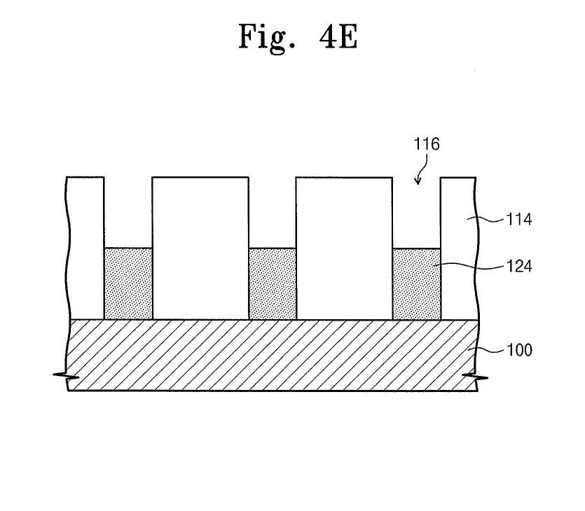

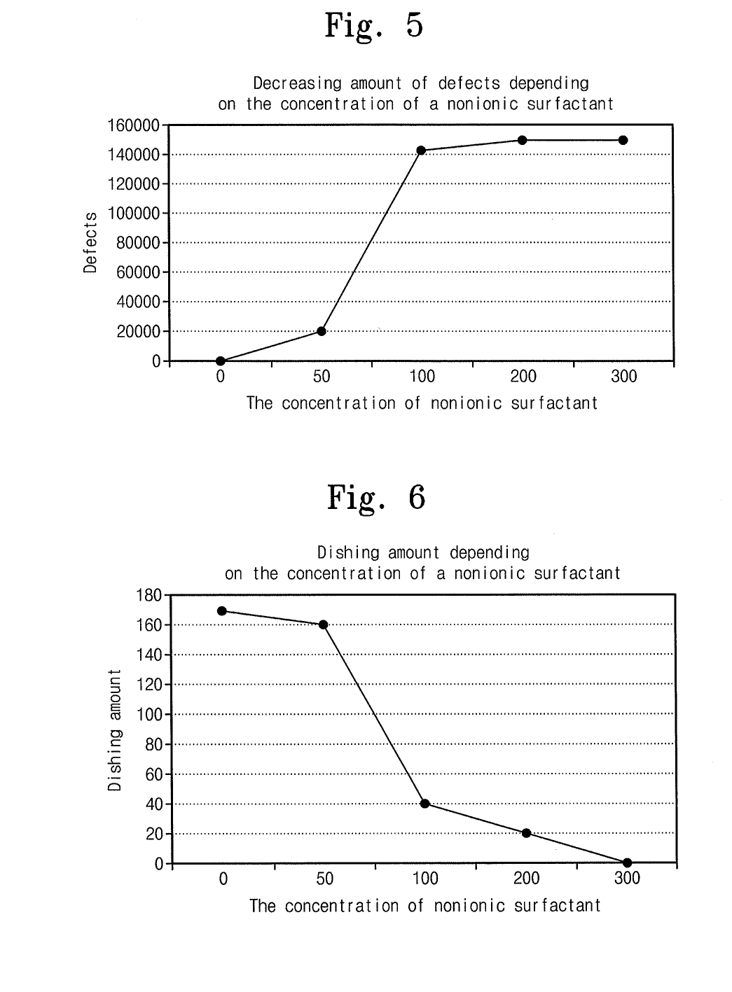

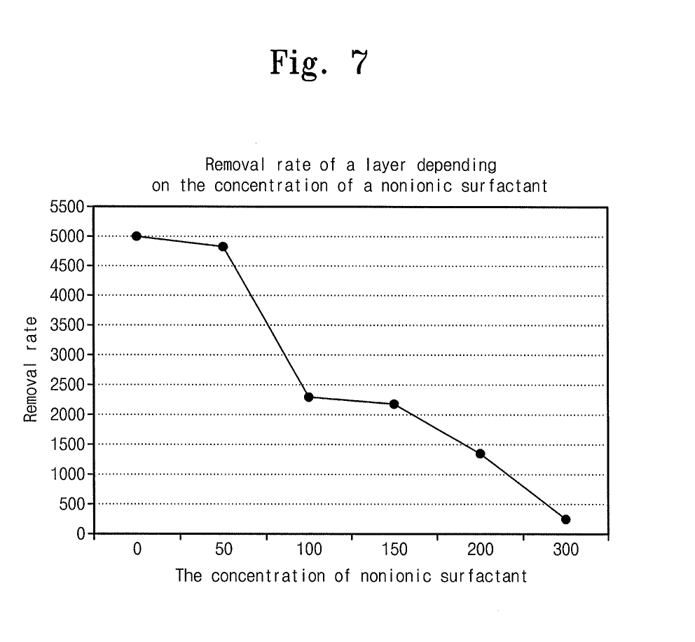

Table 2 represents the results relating to the degree of reduction in the number of defects generated by a chemical mechanical polishing process depending on the concentration of nonionic surfactant, the degree of dishing formed on the polishing target layer depending on the concentration of nonionic surfactant, and the change of removal rate of the polishing target layer depending on the concentration of nonionic surfactant. FIG. 5 illustrates a graph showing the number of reduced defects depending on the concentration of nonionic surfactant described in Table 2. FIG. 6 illustrates a graph showing a dishing amount depending on the concentration of nonionic surfactant described in Table 2. FIG. 7 illustrates a graph showing a removal rate of a polishing target layer depending on the concentration of nonionic surfactant described in Table 2.

As shown in Table 2 and FIG. 5, unlike the samples 1 and 2 (which contained less than 100 ppb of nonionic surfactant in the slurry composition) the number of reduced defects (e.g., number of defects prevented) rapidly increased to more than 100,000 in the samples 3 through 5 (which contained 100 ppb or more of the nonionic surfactant in the slurry composition). Therefore, it may be seen that if a slurry composition containing less than 100 ppb of the nonionic surfactant is used in a chemical mechanical polishing process, the number of undesirable defects generated on a wafer may be increased.

As shown in Table 2 and FIG. 6, the samples 1 and 2 (which contained less than 100 ppb of the nonionic surfactant in the slurry composition) exhibited 100 Å or more of a dishing phenomenon. However, the samples 3 through 5 (which contained 100 ppb or more of the nonionic surfactant in the slurry composition) exhibited less than 100 Å of a dishing phenomenon. Therefore, it may be seen that if a slurry composition contains 100 ppb or more of a nonionic surfactant is used in a chemical mechanical polishing process, undesirable dishing in a polishing target layer may be decreased.

As shown in Table 2 and FIG. 7, the removal rate of a layer was about 326 Å/min in the sample 5 that contained the nonionic surfactant in a concentration of about 300 ppb in the slurry composition. In the case where the nonionic surfactant is contained at a concentration greater than 300 ppb in the slurry composition, the removal rate of a layer may rapidly decrease such that the nonionic surfactant may not be appropriate for a slurry composition to remove a polishing target layer. Therefore, in the case where a nonionic surfactant is included in a concentration of less than 300 ppb in the slurry composition, an appropriate level of the removal rate of a layer may be obtained to improve a process margin of a chemical mechanical polishing process.

According to the above experimental results, a chemical mechanical polishing process may be performed on the polishing target layer 141 using a slurry composition containing the nonionic surfactant 46 in a concentration of about 100 ppb to about 300 ppb, thereby minimizing the occurrence of defects on the wafer 200 and facilitating an improvement in the process margin of the chemical mechanical polishing process.

The slurry composition may further include at least one of a pH value regulator or an oxidant. The pH value regulator may include at least one of an inorganic acid, an organic acid, and a base. For example, the pH value regulator may include at least one of inorganic acids, e.g., sulfuric acid, hydrochloric acid, nitric acid, phosphoric acid, and the like, organic acids, e.g., acetic acid, citric acid, and the like, and bases, e.g., sodium hydroxide, potassium hydroxide, ammonium hydroxide, organic ammonium salt, and the like. The pH value regulator may be included in an amount of about 0.01 to about 0.1 mL/L in the slurry composition. The pH value regulator may not only improve slurry stability through an appropriate pH value adjustment, but may also be able to chemically polish the surface of the polishing target layer 141 on which a polishing process is performed.

The oxidant may be a material having a higher standard redox potential than a phase change material contained in the polishing target layer 141. For example, the oxidant may include at least one of hydrogen peroxide, a monopersulfate compound, a dipersulfate compound, an ionic iron compound, and an iron chelate compound. The oxidant may be included in the slurry composition in an amount of about 1 to about 100 mL/L. The oxidant may oxidize a surface of the polishing target layer 141 with oxides or ions such that the surface of the polishing target layer 141 may be easily removed and evenly polished. Therefore, surface roughness of the polishing target layer 141 (which may occur after the chemical mechanical polishing process) may be improved.

A slurry composition according to the embodiments may chemically and mechanically polish the polishing target layer 141 containing the phase change material. The phase change material may contain a chalcogenide compound. The chalcogenide compound may include at least one of tellurium (Te) and selenium (Se), which are chalcogenide elements. Also, the chalcogenide compound may include at least one of antimony (Sb), germanium (Ge), bismuth (Bi), lead (Pb), tin (Sn), silver (Ag), arsenic (As), sulfur (S), silicon (Si), phosphorus (P), oxygen (0), and nitrogen (N), which are pnictogenide-based elements. For example, the phase change material may be formed at least one of an indium (In)-Se compound, a Sb—Te compound, a Ge—Te compound, a Ge—S—Te compound, an In—Sb—Te compound, a gallium (Ga)—Se—Te compound, a Sn—Sb13 Te compound, an In—Sb—Ge compound, an Ag—In—Sb—Te compound, a Ge—Sn—Sb—Te compound, a Te—Ge—Sb—S compound, an As—Sb—Te compound, and an As—Ge—Sb—Te compound.

<Method of Forming a Phase Change Memory Device>

FIGS. 4A through 4D illustrate cross-sectional views of stages in a method of forming a phase change memory device according to an embodiment.

Referring to FIG. 4A, a first insulation layer 110 may be disposed on a substrate 100. The substrate 100 may include a switching device, e.g., a diode, a transistor, or the like. The first insulation layer 110 may be formed by a chemical vapor deposition process. The first insulation layer 110 may include at least one of an oxide layer, a nitride layer, and an oxynitride layer.

A first opening 112 may be formed by patterning the first insulation layer 110.

Forming the first opening 112 may include forming a mask pattern (not illustrated) on the first insulation layer 110 and etching the first insulation layer 110 using the mask pattern as an etch mask. In the case where the substrate 100 contains a switching device, the first opening 112 may expose one terminal of the switching device.

A lower electrode layer (not illustrated) filling the first opening 112 may be formed on the entire substrate 100; and a lower electrode 120 may be formed by planarizing the lower electrode layer until the first insulation layer 110 is exposed. The lower electrode 120 may be in contact with a portion of the substrate 100 exposed by the first opening 112. In the case where the substrate 100 contains a switching device, the lower electrode 120 may be electrically connected to the switching device.

The lower electrode 120 may be formed of a conductive nitride. For example, the lower electrode 120 may be formed of at least one of titanium nitride, hafnium nitride, vanadium nitride, niobium nitride, tantalum nitride, tungsten nitride, molybdenum nitride, titanium-aluminum nitride, titanium-silicon nitride, titanium-carbon nitride, tantalum-carbon nitride, tantalum-silicon nitride, titanium-boron nitride, zirconium-silicon nitride, tungsten-silicon nitride, tungsten-boron nitride, zirconium-aluminum nitride, molybdenum-silicon nitride, molybdenum-aluminum nitride, tantalum-aluminum nitride, titanium oxynitride, titanium-aluminum oxynitride, tungsten oxynitride, and tantalum oxynitride.

A second insulation layer 130 may be disposed on the lower electrode 120 and the first insulation layer 110. The second insulation layer 130 may be formed by a chemical vapor deposition process. The second insulation layer 130 may include at least one of an oxide layer, a nitride layer, and an oxynitride layer. In an implementation, the first insulation layer 110 and the second insulation layer 130 may be formed of the same material.

A second opening 135 may be formed by patterning the second insulation layer 130. The second opening 135 may expose an upper surface of the lower electrode 120. A bottom surface of the second opening 135 may be wider than the upper surface of the lower electrode 120. Forming the second opening 135 may include forming a mask pattern (not illustrated) on the second insulation layer 130 and etching the second insulation layer 130 using the mask pattern as an etch mask. In an implementation, etching the second insulation layer 130 may be performed by a dry etching process.

Referring to FIG. 4B, a phase change material layer 140 may be disposed on the entire surface of the substrate 100. The phase change material layer 140 may contain a phase change material that can transform to states having a different specific resistivity from each other. The phase change material layer 140 may contain a chalcogenide compound. The chalcogenide compound may include at least one of tellurium (Te) and selenium (Se), which are chalcogenide elements. Also, the chalcogenide compound may include at least one of antimony (Sb), germanium (Ge), bismuth (Bi), lead (Pb), tin (Sn), silver (Ag), arsenic (As), sulfur (S), silicon (Si), phosphorus (P), oxygen (0) or nitrogen (N), which are pnictogenide-based elements. For example, the phase change material layer 140 may be formed of at least one of an indium (In)-Se compound, a Sb—Te compound, a Ge—Te compound, a Ge—Sb—Te compound, an In—Sb—Te compound, a gallium (Ga)—Se—Te compound, a Sn—Sb—Te compound, an In—Sb—Ge compound, an Ag—In—Sb—Te compound, a Ge—Sn—Sb—Te compound, a Te—Ge—Sb—S compound, an As—Sb—Te compound, and an As—Ge—Sb—Te compound. In an implementation, the phase change material layer 140 may be formed by a physical vapor deposition process or a chemical vapor deposition process.

Referring to FIG. 4C, a phase change pattern 145 may be formed by performing a chemical mechanical polishing process on the phase change material layer 140 using the slurry composition according to an embodiment.

The chemical mechanical polishing process may be performed under process conditions of: a polishing pressure of about 200 to about 250 hPa, a revolution per minute (rpm) of a polishing head of about 50 to about 150 rpm, and a rpm of a polishing table of about 50 to about 100 rpm.

The slurry composition of an embodiment used in the chemical mechanical polishing process may be a mixed composition of abrasive particles and a nonionic surfactant in deionized water. The abrasive particles may include, e.g., metal oxide, polymer synthetic particles, and combinations thereof For example, the metal oxide may include at least one of ceria, silica, alumina, titania, zirconia, mangania, and germania. The polymer synthetic particles may include at least one of abrasive particles comprised of a polymer itself, abrasive particles of metal oxide coated with a polymer, and abrasive particles of a polymer coated with metal oxide. The abrasive particles may have an average particle diameter of about 1 to about 300 nm and an average specific surface area of about 10 to about 500 m²/g. The abrasive particles may be included in the slurry composition in an amount of about 0.01 to about 30 wt %. The abrasive particles may mechanically polish a surface of the phase change material layer 140.

The nonionic surfactant may contain a hydrophilic group portion and a hydrophobic group portion. The nonionic surfactant may include at least one as a hydrophilic group portion of a polymer material containing a hydroxyl group as a functional group, a polymer material containing an ester bond, a polymer material containing an acid amide bond and a polymer material containing an ether bond. For example, the nonionic surfactant may be a material represented by the following formula. In the following formula, x and y may be natural numbers larger than 0.

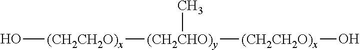

The nonionic surfactant may be included in the slurry composition in a concentration of about 100 to about 300 ppb. Depending on the concentration of the nonionic surfactant, the number of defects and dishing generated in the chemical mechanical polishing process may be changed. For example, maintaining the concentration of the nonionic surfactant in the slurry composition at about 100 ppb or greater may help ensure that polishing residues generated during the chemical mechanical polishing process are not readsorbed on the phase change material layer 140, thereby preventing defects of a phase change memory device. In addition, maintaining the concentration of the nonionic surfactant at about 100 ppb or greater may help prevent an increase in the dishing amount of the phase change pattern 145 formed by the chemical mechanical polishing process, thereby preventing an increase in the occurrence of defects caused by the dishing of the phase change memory device. Maintaining the concentration of the nonionic surfactant in the slurry composition at about 300 ppb or less may help prevent a reduction in the removal rate of the phase change material layer 140, thereby ensuring formation of the phase change pattern 145. Therefore, when the nonionic surfactant is included in a concentration of about 100 ppb to about 300 ppb, the occurrence of defects in the phase change memory device caused by defects and dishing of the phase change material layer 140 may be minimized in the chemical mechanical polishing process, and the process margin of the chemical mechanical polishing process may be improved.

The slurry composition may further include at least one of a pH value regulator or an oxidant. The pH value regulator may include at least one of an inorganic acid, an organic acid, and a base. For example, the pH value regulator may include at least one of inorganic acids, e.g., sulfuric acid, hydrochloric acid, nitric acid, phosphoric acid, or the like, organic acids, e.g., acetic acid, citric acid, or the like, and bases, e.g., sodium hydroxide, potassium hydroxide, ammonium hydroxide, organic ammonium salt, or the like. The pH value regulator may be included in the slurry composition in an amount of about 0.01 to about 0.1 mL/L. The pH value regulator may not only improve slurry stability through an appropriate pH value adjustment, but may also be able to chemically polish the surface of the phase change material layer 140.

The oxidant may be a material having a higher standard redox potential than the phase change material layer 140. For example, the oxidant may include at least one of hydrogen peroxide, a monopersulfate compound, a dipersulfate compound, an ionic iron compound, and an iron chelate compound. The oxidant may be included in the slurry composition in an amount of about 1 to about 100 mL/L. The oxidant may oxidize the surface of the phase change material layer 140 with oxides or ions such that the surface of the phase change material layer 140 may be easily removed and evenly polished. Therefore, surface roughness of the phase change pattern 145 (which may be formed after the chemical mechanical polishing process) may be improved.

Referring to FIG. 4D, an upper electrode 150 may be formed on the phase change pattern 145. The upper electrode 150 may be formed of a conductive material. For example, the upper electrode 150 may include a titanium-nitrogen compound (TiN), a tantalum-nitrogen compound (TaN), a molybdenum-nitrogen (MoN) compound, a niobium-nitrogen compound (NbN), a silicon-titanium-nitrogen compound (TiSiN), an aluminum-titanium-nitrogen compound (TiAlN), a boron-titanium-nitrogen compound (TiBN), a silicon-zirconium-nitrogen compound (ZrSiN), a silicon-tungsten-nitrogen compound (WSiN), a boron-tungsten-nitrogen compound (WBN), an aluminum-zirconium-nitrogen compound (ZrAlN), a silicon-molybdenum-nitrogen compound (MoSiN), an aluminum-molybdenum-nitrogen compound (MoAlN), a silicon-tantalum-nitrogen compound (TaSiN), an aluminum-tantalum-nitrogen compound (TaAlN), a titanium-oxygen-nitrogen compound (TiON), an aluminum- titanium-oxygen-nitrogen compound (TiAlON), a tungsten-oxygen-nitrogen compound (WON), a tantalum-oxygen-nitrogen compound (TaON), titanium, tungsten, molybdenum, tantalum, titanium silicide, tantalum silicide, graphite, and/or combinations thereof

According to an embodiment, a barrier layer (not illustrated) may be disposed between the phase change pattern 145 and the upper electrode 150. The barrier layer may be a material including at least one of titanium (Ti), tantalum (Ta), molybdenum (Mo), hafnium (Hf), zirconium (Zr), chromium (Cr), tungsten (W), niobium (Nb) and vanadium (V), and further including at least one of nitrogen (N), carbon (C), aluminum (Al), boron (B), phosphorus (P), oxygen (O) and silicon (Si), and combinations thereof For example, the barrier layer may include at least one of a titanium-nitrogen compound (TiN), a titanium-tungsten compound (TiW), a titanium-carbon-nitrogen compound (TiCN), a titanium-aluminum-nitrogen compound (TiAlN), a titanium-silicon-carbon compound (TiSiC), a tantalum-nitrogen compound (TaN), a tantalum-silicon-nitrogen compound (TaSiN), a tungsten-nitrogen compound (WN), a molybdenum-nitrogen compound (MoN), and a carbon-nitrogen compound (CN).

In an implementation, the lower electrode of the phase change memory device may be formed by a method different from that described above. Hereinafter, a method of forming the lower electrode of a phase change memory device will be described. FIG. 4E illustrates a cross-sectional view of stage in a modified embodiment relating to a method of forming a lower electrode of a phase change memory device.

Referring to FIG. 4E, an insulation layer 114 may be disposed on a substrate 100. The substrate 100 may include a switching device, e.g., a diode, a transistor, or the like. The insulation layer 114 may be formed by a chemical vapor deposition process. The insulation layer 114 may include at least one of an oxide layer, a nitride layer, and an oxynitride layer.

An opening 116 may be formed by patterning the insulation layer 114. The forming of the opening 116 may include forming a mask pattern (not illustrated) on the insulation layer 114 and etching the insulation layer 114 using the mask pattern as an etch mask. The etching of the insulation layer 114 may be performed by a dry etching process. The opening 116 may expose a portion of the substrate 100. In the case where the substrate 100 contains a switching device, the opening 116 may expose a portion of the switching device.

A lower electrode 124 filling a lower region of the opening 116 may be formed. The forming of the lower electrode 124 may include forming a lower electrode layer (not illustrated) on the entire substrate 100, planarizing the lower electrode layer until the insulation layer 114 is exposed, and forming the lower electrode 124 by recessing the planarized lower electrode layer to a level lower than the upper surface of the insulation layer 114. Therefore, an upper surface of the lower electrode 124 may be lower than an upper surface of the insulation layer 114. The lower electrode 124 may be in contact with a portion of the substrate 100 exposed by the opening 116. In the case where the substrate 100 contains a switching device, the lower electrode 124 may be electrically connected to one terminal of the switching device.

The lower electrode 124 may be formed of a conductive nitride. For example, the lower electrode 124 may be formed of at least one of a titanium-nitrogen compound, a hafnium-nitrogen compound, a vanadium-nitrogen compound, a niobium-nitrogen compound, a tantalum-nitrogen compound, a tungsten-nitrogen compound, a molybdenum-nitrogen compound, a titanium-aluminum-nitrogen compound, a titanium-silicon-nitrogen compound, a titanium-carbon-nitrogen compound, a tantalum-carbon-nitrogen compound, a tantalum-silicon-nitrogen compound, a titanium-boron-nitrogen compound, a zirconium-silicon-nitrogen compound, a tungsten-silicon-nitrogen compound, a tungsten-boron-nitrogen compound, a zirconium-aluminum-nitrogen compound, a molybdenum-silicon-nitrogen compound, a molybdenum-aluminum-nitrogen compound, a tantalum-aluminum-nitrogen compound, a titanium-oxygen-nitrogen compound, a titanium-aluminum-oxygen-nitrogen compound, a tungsten-oxygen-nitrogen compound, and a tantalum-oxygen-nitrogen compound.

Prior to forming the lower electrode 124, a spacer (which covers a sidewall of the opening 116) may be formed in the opening 116. The spacer may include at least one of an oxide layer, a nitride layer, and an oxynitride layer. An upper surface of the spacer may be formed at a same level as the upper surface of the lower electrode 124.

Thereafter, a phase change pattern (not illustrated) may be formed in the opening 116 (in which the lower electrode 124 is disposed) according to the same method as described with reference to FIGS. 4B through 4D.

As described above, a slurry composition according to the embodiments may include abrasive particles and a nonionic surfactant at a concentration of about 100 ppb to about 300 ppb. Therefore, readsorption of polishing residues (which may be generated during a chemical mechanical polishing process on a polishing target layer containing a phase change material using the slurry composition) may be minimized. Also, the etch rate of the polishing target layer may be adjusted to an appropriate level. In addition, the process margin of the chemical mechanical polishing process may be improved due to the slurry composition.

Furthermore, a chemical mechanical polishing process using the slurry composition may be used during formation of a phase change memory device, thereby preparing a phase change memory device with excellent reliability and superior electrical properties.

The embodiments provide a slurry composition that improves reliability of a chemical mechanical polishing process performed on a polishing target layer containing a phase change material.

The embodiments also provide a method of forming a phase change memory device having improved electrical properties and reliability.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

1. A slurry composition for chemical mechanical polishing of a polishing target layer containing a phase change material, the slurry composition comprising:
abrasive particles; and
a nonionic surfactant,
wherein a concentration of the nonionic surfactant in the slurry composition is about 100 ppb to about 300 ppb.

2. The composition as claimed in claim 1, wherein the abrasive particles include at least one of ceria, silica, alumina, titania, zirconia, mangania, and germania.

3. The composition as claimed in claim 1, wherein the abrasive particles include polymer synthetic particles.

4. The composition as claimed in claim 1, wherein the nonionic surfactant includes at least one of a polymer material containing a hydroxyl group, a polymer material containing an ester bond, a polymer material containing an acid amide bond and a polymer material containing an ether bond.

5. The composition as claimed in claim 1, further comprising at least one of a pH value regulator and an oxidant.

6. The composition as claimed in claim 5, wherein the composition includes the pH value regulator, the pH value regulator including at least one of an inorganic acid, an organic acid, and a base.

7. The composition as claimed in claim 6, wherein the pH value regulator includes nitric acid.

8. The composition as claimed in claim 5, wherein the composition includes the oxidant, the oxidant including at least one of hydrogen peroxide, a monopersulfate compound, a dipersulfate compound, an ionic iron compound, and an iron chelate compound.

9. The composition as claimed in claim 1, wherein the phase change material contains a chalcogenide compound.

10. The composition as claimed in claim 9, wherein the chalcogenide compound is a germanium-antimony-tellurium (GST) compound.

11-17. (canceled)

18. A chemical mechanical polishing slurry composition, comprising:
abrasive particles; and
a nonionic surfactant,
wherein the slurry composition has a layer removal rate of about 2,284 Å/min to about 326 Å/min when used to polish a phase change material layer.

19. The chemical mechanical polishing slurry composition as claimed in claim 18, wherein the slurry composition causes dishing of about 40 Å or less when used to polish a phase change material layer.
